(19) United States
(12) Patent Application Publication
(10) Pub. No.: US 2007/0000139 A1
(43) Pub. Date: Jan. 4, 2007

(54) LASER LEVELING DEVICE

(75) Inventor: Ming Chen, Nanjing (CN)

Correspondence Address: WALLENSTEIN & WAGNER, LTD., 311 SOUTH WACKER DRIVE, 53RD FLOOR, CHICAGO, IL, 60606, US

(73) Assignee: NANJING CHERVON INDUSTRY CO., LTD., Nanjing Jiangning (CN)

(21) Appl. No.: 11/427,281

(22) Filed: Jun. 28, 2006

(30) Foreign Application Priority Data
Jun. 30, 2005 (CN) 200520073176.6

(51) Int. Cl. G01C 15/00

(52) U.S. Cl. 33/286

(57) ABSTRACT

The present invention is to provide a laser leveling device that can generate a laser line at arbitrary angular positions within a predetermined angle range. The laser leveling device includes a housing, a laser generating module for generating a fan-shaped laser line on a vertical object surface to form a laser line thereon. The laser generating module is connected to the housing with a shaft-connection structure having an axis perpendicular to the vertical object surface, The laser leveling device further includes an electronic inclinometer module provided inside the housing and fixed relative to the laser generating module, and an electronic display module for displaying the angle of the laser line rotating around the axis with respect to a reference line. With this structure, the user can visually observe the angle of the laser line with respect to the reference line to conveniently and rapidly set the laser line in a desired angle.

### CROSS-REFERENCE TO RELATED APPLICATIONS

This application claims priority to Chinese Application No. 200520073176.6, filed on Jun. 30, 2005, the entire disclosure of which is incorporated herein by reference. Priority to this application is claimed under 35 U.S.C. 119, 120 and/or 365.

### TECHNICAL FIELD

The present invention relates to a laser leveling device that can generate a fan-shaped beam of laser and project it onto an object surface to form a laser line as an orientation reference line adapted for other operations.

### BACKGROUND OF THE INVENTION

In a variety of fields, such as, construction, engineering, house decorating, it is well known that a laser leveling device is used to generate and project a beam of laser light onto an object surface to form an orientation reference line adapted for other operations.

With the continuous development of the laser leveling technology, the laser leveling device can not only project the laser line onto a vertical object surface to form a reference line in vertical or horizontal direction but also can rotate the laser line. However, the conventional laser leveling device with rotary laser line still has some drawbacks to be solved. For example, Chinese Patent Publication Number CN 2588326Y has disclosed a laser leveling device, with which the laser line projected onto the vertical object surface can be rotated in a range of 0° to 90° and can be stopped in two positions, that is 0° and 90°. Such laser leveling devices may thus have limited utility.

The present invention is provided to solve the problems discussed above and other problems, and to provide advantages and aspects not provided by prior devices of this type. A full discussion of the features and advantages of the present invention is deferred to the following detailed description, which proceeds with reference to the accompanying drawings.

### SUMMARY OF THE INVENTION

An object of the present invention is to provide a laser leveling device which can generate a laser line onto a vertical object surface in any angular position in a range of a predetermined angle so as to meet requirements of the laser line in a position of a particular angle.

Another object of the present invention is to provide a laser leveling device, which can directly display an angle value of the laser line to the horizontal or vertical direction so as to reduce the error caused by the user's misreading.

In order to achieve the above-mentioned objects, a laser leveling device according to the present invention includes a housing, a laser generating module which is connected to the housing via a shaft-connection structure, an axis of which is perpendicular to the vertical object surface, for generating a fan-shaped beam of laser light onto a vertical object surface to form a laser line thereon. The laser leveling device further includes an electronic inclinometer module provided inside the housing and fixed relative to the laser generating module, and an electronic displaying module for displaying the angle of the laser line rotated around the axis from a starting line. With this structure, the user can visually observe the angle of the laser line rotated from the starting line to conveniently and rapidly set the laser line in a desired angle position.

As an improvement of the laser leveling device according to the present invention, the electronic displaying module can be a liquid crystal display module (LCD) or a light emitting diode (LED) array displaying module.

As a further improvement of the laser leveling device according to the present invention, the angle value measured by the electronic inclinometer module is directly displayed via the electronic display module in a numeric manner without the user's reading so as to eliminate the error caused by the misreading and thus to improve the measuring veracity.

The electronic inclinometer module has an obliquity measuring reference axis. As a further improvement of the laser leveling device according to the present invention, when the electrical inclinometer module is in a zero angle state, the obliquity measuring reference axis is in a horizontal position or a vertical position in a plane parallel to the vertical object surface. In this manner, the angle measured by the electronic inclinometer module is the angle relative to the horizontal or vertical position.

As a further improvement of the laser leveling device according to the present invention, the housing of the laser leveling device has at least a portion mounted on a surface to be placed and is connected with the electronic display module to prevent the electronic display module moving with respect to the rotation of the laser generating module. Thus, during the rotation of the laser generating module, the user always can conveniently observe the value displayed on the display module.

The other features and advantages of the present invention will be more clearly understood with reference to the following detailed description taken in conjunction with the accompanying drawings.

### BRIEF DESCRIPTION OF THE DRAWINGS

The attached drawings depict a preferred embodiment according to the present invention.

FIG. 1 is a perspective schematic view of a laser leveling device according a preferred embodiment of the present invention.

FIG. 2 is a schematic view depicting the inner structure of the laser leveling device of FIG. 1.

FIG. 3 is a schematic view depicting the shaft-connection structure between an upper housing and a lower housing of the laser leveling device of FIG. 1.

FIGS. 4a, 4b and 4c are schematic views depicting the connecting relationship between a laser generating module and an electronic inclinometer module of the laser leveling device of FIG. 1.

FIG. 5 is a schematic view depicting varied positions of the laser leveling device during the operation process.

### DETAILED DESCRIPTION

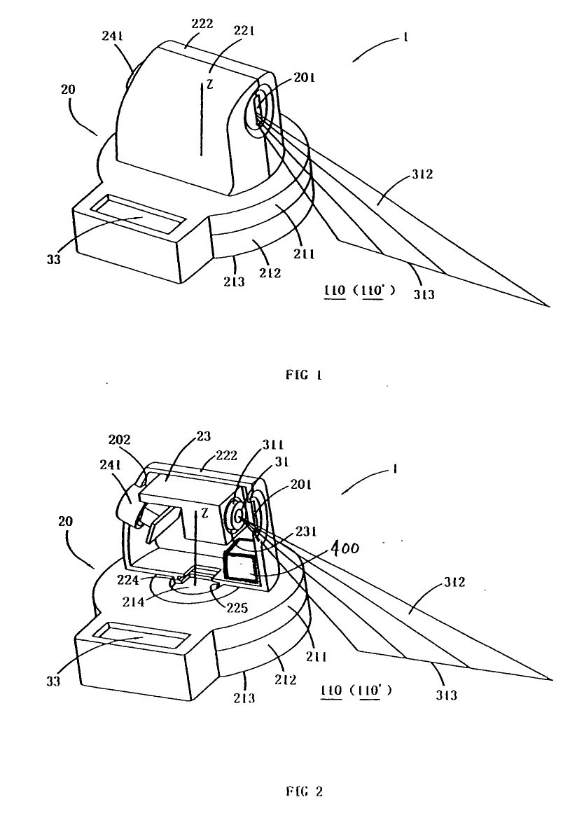

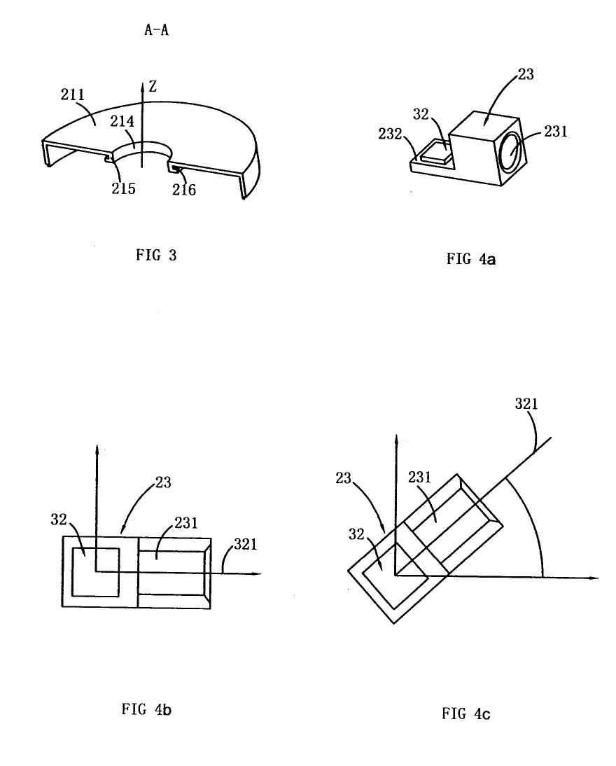

Referring to FIGS. 1, 2 and 3, a laser leveling device 1 according to a preferred embodiment of the present invention is presented. The laser leveling device 1 includes a housing 20, a laser generating module 31, an electronic inclinometer module 32 and an electronic display module 33. In the present preferred embodiment, the housing 20 has a lower housing consisted of an upper section 211 and a lower section 212, and an upper housing consisted of a left half-section 221 and a right half-section 222. The laser leveling device 1 further includes a power source (not shown) appropriately disposed in a suitable position of the upper housing or the lower housing, and a switch 241 provided in the hole 202 on the back of the upper housing.

The lower section 212 of the lower housing has a bottom surface 213. It is preferable that some fixing devices (not shown), for example, fixing pins, adhesive tapes, magnets, etc., can be provided or additionally attached to the bottom surface 213 for holding the housing 20 on a surface 110. U.S. Pat. No. 5,063,679 and U.S. Publication Nos. 2004/0187327A1 and 2004/0123473A1 have disclosed such kinds of fixing devices in detail. A circular hole 214 with a central axis Z is formed in the upper section 211 of the lower housing. An annular protruding portion 215 being coaxial with the circular hole 214 and having an inner radius identical with the radius of the circular hole 214 is provided on the bottom surface of the upper section 211 of the lower housing. An annular groove 216 is formed in the outer circumferential surface of the annular protruding portion 215.

Both of the front surfaces of the left section 221 and the right section 222 of the upper housing have a recess to form an opening 201 in the front surface of the upper housing. The bottom of the right section 222 of the upper housing has a semi-annular projection 224 with an outer radial size approximately identical with the radius of the circular hole 214 in the upper section 211 of the lower housing. The inner circumferential surface of the semi-annular projection 224 has a groove 225 thereon. In the corresponding position, the bottom of the left section 221 of the upper housing has an identical semi-annular projection (not shown) in this manner to form an annular protruding portion on the bottom of the upper housing. The annular protruding portion of the upper housing is disposed in the circular hole 214 of the upper section 211 of the lower housing to form such a shaft-connection structure that the upper housing is enabled to rotate about the axis Z relative to the lower housing. At least one U-shaped elastic clip (not shown) is provided with one end thereof snapped in the groove 225 in the inner circumferential surface of the annular projection portion of the upper housing and another end thereof snapped in the groove 216 in the outer circumferential surface of the annular protruding portion 215 of the lower housing so as to prevent the upper housing disengaging with the lower housing. Moreover, with the friction caused between the elastic clip and said grooves, the upper housing can be stopped on arbitrary positions relative to the lower housing. It would be appreciated by one skilled in the art that this kind of shaft-connection structure could be embodied in other means without departing from the principles of the present invention.

The laser generating module 31 includes a housing 311, a laser generator (not shown) inside the housing 311 and at least one optical element (not shown) inside or outside the housing 311. The laser generator generates a laser beam that forms a fan-shaped laser line 312 with the effect of the optical element. In this preferred embodiment, the surface 110 on which the laser leveling device 1 is placed is a vertical object surface 110′ perpendicular to the central axis Z of the circular hole 214. The fan-shaped beam of the laser 312 generated by the laser generating module 31 passes through the opening 201 in the front surface of the upper housing and projects onto the vertical object surface 110′ to form a laser line 313 thereon. A connecting member 23 with a hole 231 shaped to receive a casing 311 of the laser generating module 31 is provided inside the upper housing. With the above-mentioned structure, while the upper housing is rotated about the axis Z relative to the lower housing, the laser generating module 31 is driven to rotate about the axis Z, so that the laser line 313 formed on the vertical object surface 110′ also is rotated about the axis Z.

The electronic inclinometer module 32 could be selected from the solid-pendulum type inclinometers (with reference to Chinese Patent No. 00223002.x, U.S. Pat. No. 3,691,850), hot gas mass convection inclinometers (with reference to Chinese Patent No. 92100599.7, and U.S. Pat. No. 5,581,034), or the liquid type inclinometers (with reference to Chinese Patent No. 86100001, and U.S. Pat. No. 4,676,103). As shown in FIGS. 4a-4c, the electronic inclinometer module 32 has an obliquity measuring reference axis 321. Generally, the state of the obliquity measuring reference axis 321 being in horizontal position is set as the zero angle state of the electronic inclinometer module 32. If the obliquity measuring reference axis 321 is departed from the horizontal position, the angle measured by the electronic inclinometer module 32 is an angle β of the obliquity measuring reference axis 321 with respect to the horizontal position. This kind of electronic inclinometer module is capable of continuously measuring the obliquity in a range of 0° to 90°. Some electronic inclinometer modules are even capable of continuously measuring the obliquity in a range of 0°to 360°. Of course, the state of the obliquity measuring reference axis 321 being in vertical position also could be set as the zero angle state of the electronic inclinometer module 32.

The connecting member 23 further has a plane 232 which is parallel to the vertical object surface 110′ and on which the electronic inclinometer module 32 is attached to be rotated with the laser generating module 31. Preferably, the obliquity measuring reference axis 321 of the electronic inclinometer module 32 is parallel to the laser line 313. In this manner, if the laser leveling device 1 is attached to the vertical object surface, the angle measured by the electronic inclinometer module 32 is the angle of the laser line 313 with respect to the horizon.

The electronic display module 33 is a liquid crystal display (LCD) module or a low emitting diode (LED) array display module, which is secured to the protruding portion 215 of the upper section 211 of the lower housing. Thus, during the process of the laser line 313 rotating about the axis Z, the electronic displaying module 33 does not move together with the laser line 313 so that the user always can conveniently observe the measured angle of the laser line with respect to the horizon. The electronic inclinometer module 32 is electrically connected to the electronic display module 33 with the wire (not shown) which extends through the hole 214. It is preferable that a stopper member is provided between the annular projection of the upper housing and the hole 214 or the protruding portion 215 of the lower housing to limit the movement of the laser generating module 31 relative to the lower housing within a certain range, for example, 180° or 360°, so as to prevent the wire from being damaged. The angle value measured by the electronic inclinometer module 32 is displayed on the electronic display module 33 in numeric manner. As compared with other displaying manners, for example, the annular dial displaying manner, the angle value is displayed directly in numeric manner with the LCD or LED, and can directly show the measured angle without user's reading. Thus, the device according to the present invention is convenient for users and can eliminate the error artificially caused by misreading the display.

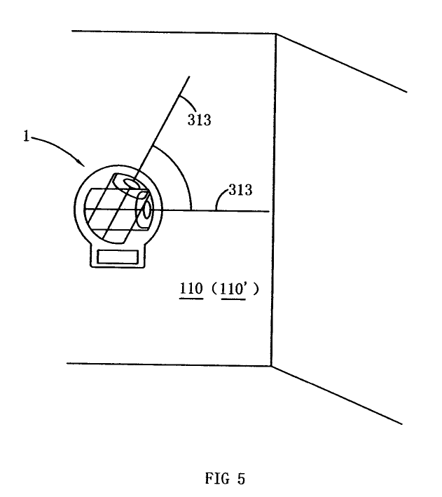

As shown in FIG. 5, during the operation, a user can mount the laser leveling device 1 on the surface 110 to be placed and rotate the upper housing provided with the laser generating module 31 and the electronic inclinometer module 32. The value of an angle of the laser line 313 projected on the vertical object surface 110′ with respect to the horizon then is displayed on the electronic display module attached to the lower housing. Then, the user can conveniently and rapidly set the laser line 313 in any angle position.

It will be easily understood by one skilled in the art that the laser generating module and the electronic inclinometer module also could be directly connected to the housing through a shaft-connection structure. Moreover, one skilled in the art can conceive that the laser leveling device according to the present invention also could be put on a horizontal placement plane, in which the fan-shaped beam of the laser line generated by the laser generating module will be projected onto a vertical object surface to form a rotatable laser line.

What is shown and described in connection with the preferred embodiments is not intended to limit the scope of the present invention, but to explain and state the concept and principle of the invention. It is apparent that certain changes and modifications, in addition to those mentioned above, may be conceived by one skilled in the art without departing from the spirit and scope outlined above. Accordingly, it is intended that the invention be defined by the appended claims.

1. A laser leveling device, comprising:
a housing;
a laser generating module for generating a fan-shaped beam of laser light on an object surface, wherein the laser generating module is connected to the housing by a shaft connection, wherein the shaft has an axis perpendicular to the object surface; and,
an upper housing, wherein the laser generating module is disposed within the upper housing, wherein the upper housing rotates on the axis in a plane parallel to the object surface.

2. The device of claim 1, further comprising:
an electronic inclinometer for providing an angle at which the beam of laser light is generated, wherein the angle is relative to the object surface.

3. The device of claim 2, wherein the electronic inclinometer is affixed to the laser generating module.

4. The device of claim 2, wherein the electronic inclinometer displays an angle at which the beam of laser light is generated, wherein the angle is relative to the axis.

5. The device of claim 2, wherein the electronic inclinometer comprises an oblique reference axis parallel to the object surface.

6. The device of claim 1, further comprising:
an electronic display module for displaying an angle at which the beam of laser light is generated.

7. The device of claim 6, wherein the electronic display module is one of a liquid crystal digital display and a light emitting diode array.

8. The device of claim 1, wherein the housing comprises at least one section to be mounted on a displacement plane, wherein the section is connected to the electronic display module.

9. The device of claim 1, wherein the laser generating module is mounted on a connecting member disposed within a plane parallel to the object surface.

10. The device of claim 9, wherein the electronic inclinometer is disposed in the plane in which the connecting member is disposed.

11. The device of claim 1, further comprising:
an aperture connected to an exterior of the housing, wherein the aperture rotates within a plane parallel to the object surface.

12. The device of claim 11, wherein the laser generating module is connected to the aperture, wherein a rotation of the aperture rotates the beam of laser light.

13. A laser leveling system, comprising:
a laser generating module for generating a beam of laser light on an object surface;
a housing in which the laser generating module is disposed, wherein the housing has a bottom surface to be disposed on a reference surface; and,
a shaft member disposed within the housing and connected to the laser generating module, wherein the shaft member is perpendicular to the reference surface, wherein the laser generating module rotates about the axis in a plane parallel to the reference surface.

14. The system of claim 13, wherein the beam of laser light is generated so as to have a fan shape.

15. The system of claim 13, further comprising:
an electronic inclinometer for providing an angle at which the beam of laser light is generated, wherein the angle is relative to the reference surface.

16. The system of claim 15, wherein the electronic inclinometer is affixed to the laser generating module.

17. The system of claim 13, wherein the electronic inclinometer displays an angle at which the beam of laser light is generated, wherein the angle is relative to the axis.

18. The system of claim 13, wherein the electronic inclinometer comprises an oblique reference axis parallel to the reference surface.

19. The system of claim 13, further comprising:
an electronic display module for displaying an angle at which the beam of laser light is generated.

20. A laser leveling device, comprising:
a housing;
a laser generating module for generating a fan-shaped beam of laser light on an object surface, wherein the laser generating module is connected to the housing by a shaft connection, wherein the shaft has an axis perpendicular to the object surface;
an upper housing, wherein the laser generating module is disposed within the upper housing, wherein the upper housing rotates on the axis in a plane parallel to the object surface;
an electronic inclinometer for providing an angle at which the beam of laser light is generated, wherein the angle is relative to the object surface; and,
an electronic display device for digitally displaying the value of the angle.

21. A laser leveling device, comprising:
a lower housing;
a laser generating module for generating a beam of laser light on an object surface, wherein the laser generating module is connected to the housing by a shaft connection, wherein the shaft has an axis perpendicular to the object surface;
an upper housing, wherein the laser generating module is disposed within the upper housing;
a reference point positioned on one of either the lower housing or the upper housing;
a processor for measuring the angle between the laser beam and the reference point, wherein the processor is disposed in one of either the lower housing or the upper housing; and,
a display module that displays the angle between the laser beam and the reference point measured by the processor.

22. The device of claim 21, wherein the upper housing rotates on the axis in a plane parallel to the object surface.

23. The device of claim 21, wherein the electronic display module is one of a liquid crystal digital display and a light emitting diode array.

24. The device of claim 21, further comprising an aperture connected to an exterior of the lower housing, wherein the aperture rotates within a plane parallel to the object surface.

25. The device of claim 24, wherein the laser generating module is connected to the aperture, wherein a rotation of the aperture rotates the beam of laser light.

26. The device of claim 21, wherein the beam of laser light is generated so as to have a fan shape.

27. The device of claim 21, wherein an actuator is connected to the laser generator for rotation of the beam of laser light.
